(19) United States
(12) Patent Application Publication
(10) Pub. No.: US 2008/0066142 A1
(43) Pub. Date: Mar. 13, 2008

(54) Digital television receiver and method for processing a digital television signal

(75) Inventor: Kwan Suk Kim, Seoul (KR)

Correspondence Address: MCKENNA LONG & ALDRIDGE LLP, 1900 K STREET, NW, WASHINGTON, DC, 20006, US

(73) Assignee: LG. Electronics, Inc., Seoul (KR)

(21) Appl. No.: 11/896,937

(22) Filed: Sep. 6, 2007

(30) Foreign Application Priority Data
Sep. 7, 2006 (KR) 10-2006-0086324

(51) Int. Cl. H04N 7/20

(52) U.S. Cl. 725/141

(57) ABSTRACT

A method comprises receiving a digital television signal including a system time table providing a current date and time of day information and an event information table containing information for events on defined virtual channels; demultiplexing the system time table and the event information table from the digital television signal; parsing current event information from the demultiplexed system time table, the current event information defining at least one of a source identification and event identification for a current event; parsing time information of a corresponding event from the demultiplexed event information table; and updating the time information of the event according to the parsed current event information.

This application claims the benefit of Korean Patent Application No. 10-2006-0086324, filed on Sep. 7, 2006, which is hereby incorporated by reference as if fully set forth herein.

### BACKGROUND

1. Field of the Disclosure

The present disclosure relates to digital television (DTV) receivers and methods for processing DTV signal.

2. Background

Generally, a program and system information protocol (PSIP) is a protocol for channel tuning and broadcast schedule transmission in Advanced Television System Committee (ATSC) as the digital broadcasting standard in terrestrial and cable digital broadcasting environments.

In addition, the PSIP is a standard protocol for the transfer of tables included within packets transferred by a multiplexed transport stream.

As the PSIP table, there is a virtual channel table (VCT) having information about a virtual channel viewed by a user with a digital television (DTV) receiver, an event information table (EIT) enabling an electronics program guide (EPG) service, and a system time table (STT) for informing information about the current time.

The EIT contains information, such as titles, start times, for events on defined virtual channels. The event is, in most cases, a typical TV program. EITs are distinguished by the index of time span and each of them is referred to as EIT-k, with k=0, 1, . . . , 127. Each EIT is represented as information in three-hour units. Moreover, each EIT may have information about one or more events.

Accordingly, a DTV receiver can obtain information on a television program that is being executed at present and/or will be executed in future through program information called events contained in the EIT, that is, the title of a desired program contained in the program information, the rating of the program, the start time of the program, the duration of the program, and the existence of caption information. In a personal video recorder (PVR), a program which will be executed in future may be reservation-recorded at the start time of a program contained in the program information.

However, since the start time and the duration of the program in the program information contained in the EIT are likely to be changed based on the situation of the broadcasting station as shown in FIG. 1, it is difficult to allow a DTV receiver to accurately perform the process. Accordingly, a portion of the beginning of the program may not be recorded or an unnecessary portion may be recorded.

### SUMMARY

Accordingly, the present disclosure is directed to digital television (DTV) receivers and methods for processing DTV signals that substantially obviate one or more problems described above.

For example, the disclosure may disclose DTV receivers and methods for processing DTV signal. The DTV signal includes current event information on an event broadcasted at the current time of DTV signal in correspondence with the time information of the event.

Advantages, objects, and features of the invention in part may become apparent in the description which follows and in part may become apparent to those having ordinary skill in the art upon examination of the following or may be learned from practice of the invention. The objectives and other advantages of the various embodiments of the invention may be realized and attained by the structures and processes described in the written description, in the claims, and in the appended drawings.

To achieve these objects and other advantages and in accordance with the purpose of the invention, as embodied and broadly described herein, a method includes receiving a digital television signal including a system time table providing a current date and time of day information and an event information table containing information for events on defined virtual channels; demultiplexing the system time table and the event information table from the digital television signal; parsing current event information from the demultiplexed system time table, the current event information defining at least one of a source identification and event identification for a current event; parsing time information of a corresponding event from the demultiplexed event information table; and updating the time information of the event according to the parsed current event information.

In another aspect of the present invention, a method includes receiving a digital television signal including a virtual channel table containing a list of attributes for virtual channels carried in transport streams and an event information table containing information for events on defined virtual channels; demultiplexing the virtual channel table and the event information table from the digital television signal; parsing current event information from the demultiplexed virtual channel table, the current event information defining an event identification for a current event; parsing time information of a corresponding event from the demultiplexed event information table; and updating the time information of the event according to the parsed current event information.

In a further aspect, a digital television receiver includes a tuner tuning to a channel to receive a digital television signal; a demodulator demodulating the digital television signal; a demultiplexer demultiplexing a system time table and an event information table from the demodulated digital television signal; a parser parsing current event information from the demultiplexed system time table and time information of a corresponding event from the demultiplexed event information table, the current event information defining at least one of a source identification and event identification for a current event; and a controller updating the time information of the event according to the parsed current event information.

In a further aspect, a digital television receiver includes a tuner tuning to a channel to receive a digital television signal; a demodulator demodulating the digital television signal; a demultiplexer demultiplexing a virtual channel table and an event information table from the demodulated digital television signal; a parser parsing current event information from the demultiplexed virtual channel table and time information of a corresponding event from the demultiplexed event information table, the current event information defining a event identification for a current event; and a controller updating the time information of the event according to the parsed current event information.

It is to be understood that both the foregoing general description and the following detailed description are exemplary and explanatory and should not be construed as limiting the scope of the claims.

### BRIEF DESCRIPTION OF THE DRAWINGS

The accompanying drawings, which are included to provide a further understanding of the disclosure are incorporated in and constitute a part of this application. The drawings together with the description serve to explain the principle of the invention. In the drawings:

FIG. 1 is an exemplary diagram of a difference between the actual start time of a program and the start time of the program contained in program information;

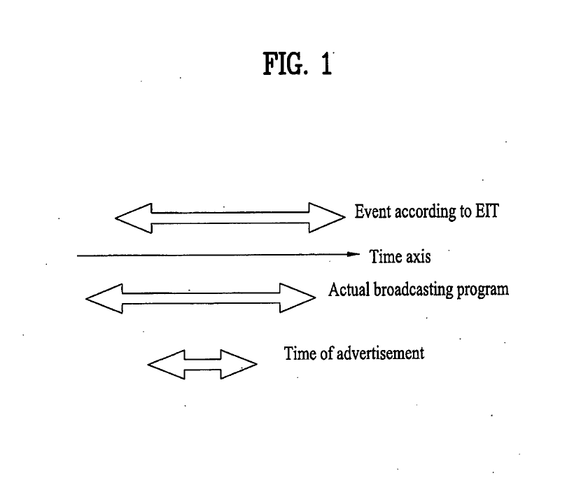

FIG. 2 is an exemplary diagram of a bit stream syntax for a system time table containing an event descriptor;

FIGS. 3A and 3B are an exemplary diagram of the event descriptor;

FIG. 4 is an exemplary process of searching for an accurate current event;

FIG. 5 is an exemplary case of using a version number when the event information in the event descriptor changes;

FIG. 6 is an exemplary diagram of a bit stream syntax terrestrial virtual channel table containing an event descriptor;

FIGS. 7A and 7B are an exemplary example of the event descriptor;

FIG. 8 is an exemplary block diagram of a digital television receiver to process a digital television signal; and

FIG. 9 is an exemplary flowchart of a method for processing a digital television signal.

### DETAILED DESCRIPTION

Reference will now be made in detail to a digital television receiver and methods for processing a digital television signal according to the various embodiments, examples of which are illustrated in the accompanying drawings. Wherever possible, the same reference numbers will be used throughout the drawings to refer to the same or like parts for simplicity.

Hereinafter, a digital television (DTV) signal containing current event information on an event broadcasted at the current time corresponding to the time information of the event, DTV receivers and methods for processing the DTV signal according to the present disclosure will be described in detail with reference to the accompanying drawings.

Hereinafter, the present disclosure is characterized in that the DTV signal contains current event information.

The current event information indicating what event is broadcasted currently may be contained in a new table or a predefined table that is then contained in the DTV signal. When the current event information is contained in the predefined table, a reserved region of the table may be used and a descriptor as an extension may be used. A variety of methods may be used, but an embodiment using the descriptor of the predefined table will be described in the present specification. The descriptor containing the current event information on an event broadcasted currently according to the present disclosure is called an event descriptor.

For convenience of description, a case where the event descriptor is contained as a descriptor of a system time table (STT) and a virtual channel table (VCT) in a PSI/PSIP table will be described in the present specification.

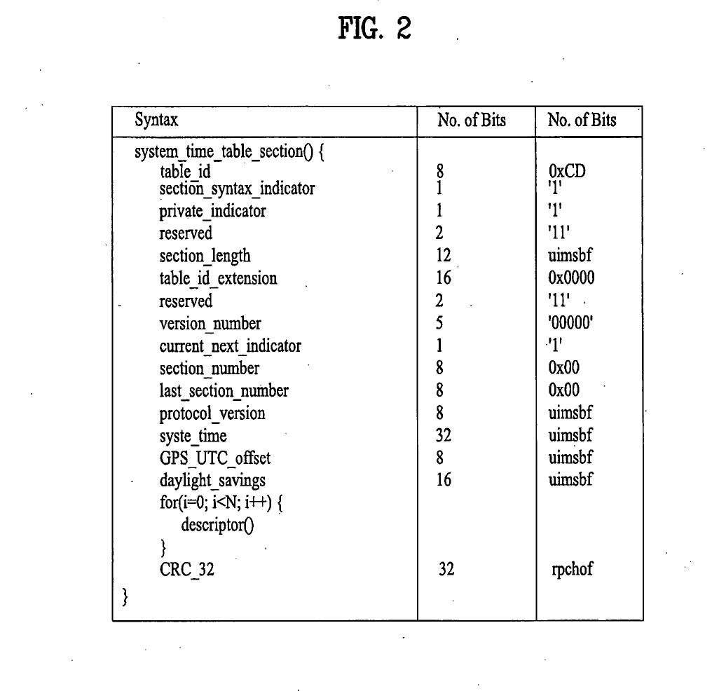

Hereinafter, the event descriptor will be defined as the descriptor contained in the STT. FIG. 2 is an exemplary diagram of a bit stream syntax for the STT containing an event descriptor.

The STT provides the current date and time of day information. The STT carries time information needed for any application requiring synchronization. The STT has a real time function for immediately applying a moment for carrying a table in a short period of 1 second or less to the time of the time information contained in the table. That is, a broadcasting station continuously provides information on the current time to a DTV receiver through the STT.

In association with the structure of the STT section, tables for special purposes are defined in the PSIP and have the section structures similar to those of the tables defined in the program specific information (PSI) of the moving picture experts group (MPEG). That is, each table has a section for transfer and may have one or a plurality of sections according to the type thereof. At this time, the section is divided into a header containing the basic information of the table and section necessary for selectively receiving the section, a message body containing the actual data of the table, and a trailer containing information for error correction.

Hereinafter, the STT section shown in FIG. 2 will be described in order of the header from a “table_id” field to a “protocol_version” field, the message body from a “system_time” field to a “descriptor( )” field, and the trailer containing “CRC_{—}32” field in the present specification.

First, the header will be described. The “table_id” field is an 8-bit field, which shall be set to ‘0xCD’, identifying this table as the STT. A “section_syntax_indicator” field is a 1-bit field, which shall be set to ‘1’. It denotes that the section follows the generic section syntax beyond the section length field. A “private_indicator” field is a 1-bit field, which shall be set to ‘1’. A “section_length” field is a 12-bit field specifying the number of remaining bytes in this section immediately following the section_length field up to the end of the section. A “table_id_extension” field is a 16-bit field, which shall be set to ‘0x0000’.

A “version_number” field is a 5-bit field, which shall update a value, when at least one of value of each field of the event descriptor is changed. A “current_next_indicator” field is a 1-bit indicator, which always set to ‘1’ for an STT section; the STT sent is always currently applicable. A “section_number” field is an 8-bit field, which shall always be ‘0x00’. A “last_section_number” field is an 8-bit field, which shall always be ‘0x00’. A “protocol_version” field is an 8-bit unsigned integer field, whose function is to allow, in the future, this table type to carry parameters that may be structured differently than those defined in the current protocol.

Next, the message body will be described. A “system_time” field is a 32-bit unsigned integer quantity representing the current system time as the number of global positioning system (GPS) seconds since 00:00:00 coordinated universal time (UTC), Jan. 6, 1980. The count of GPS seconds and leap second count shall be accurate and correct to within plus or minus one second, for a direct main broadcast signal radio frequency (RF) receiving device, as timed at the arrival in the decoder of the transport stream (TS) packet carrying the last byte of the cyclic redundancy check (CRC). The STT seconds count should be set to the next second and sent approximately 2 T milliseconds before the seconds count is due to increment, where T represents the average number of milliseconds between TS packets identified with the system information (SI) base_PID (0x1FFB). If one or more translators and/or repeaters are in the RF delivery path that introduces processing delays that impact the overall STT timing accuracy, the STT timing should be adjusted in the translated/repeated signal.

A “GPS_UTC_offset” field is an 8-bit unsigned integer that defines the current offset in whole seconds between GPS and UTC time standards. To convert GPS time to UTC, the GPS_UTC_offset is subtracted from GPS time. Whenever the International Bureau of Weights and Measures decides that the current offset is too far in error, an additional leap second may be added (or subtracted), and the GPS_UTC_offset will reflect the change. A “daylight_savings” field is Daylight Savings Time Control bytes.

A “descriptor( )” field may include one or more descriptors, as appropriate. The STT carries information on the current time and daylight saving time and may contain a descriptor as an extension. At this time, an example of the descriptor may be the event descriptor. The detailed description of the event descriptor will be described later.

Finally, the trailer will be described. A “CRC_{—}32” field is a 32-bit field that contains the CRC value that ensures a zero output from the registers in the decoder after processing the entire STT section. Up to now, the structure of the STT section was described.

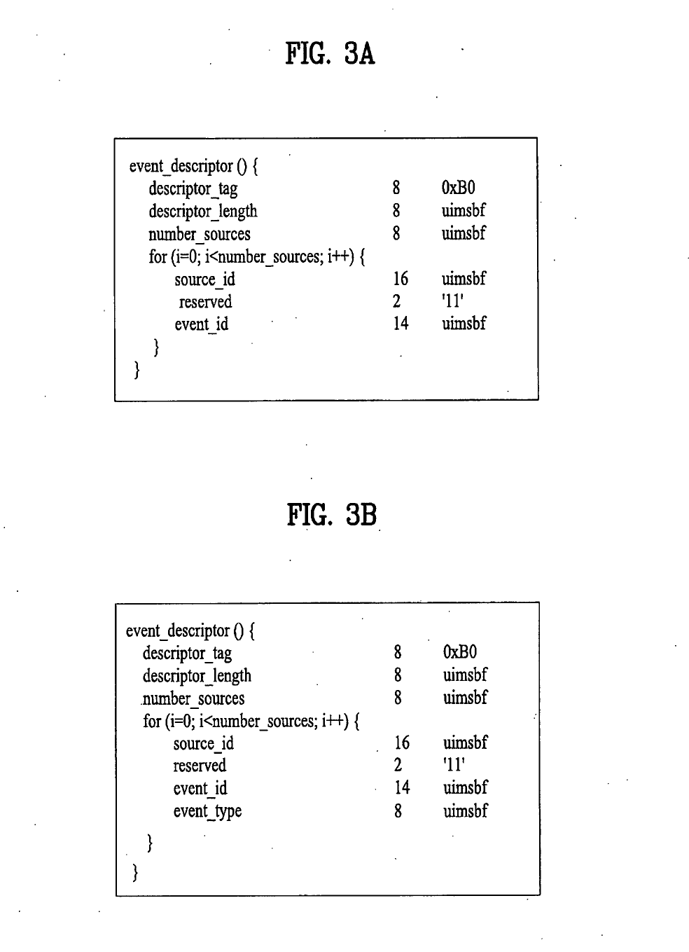

Hereinafter, the event descriptor containing the information on the event broadcasted currently in association with the time information of the event contained in the EIT of the STT section will be described. FIGS. 3A and 3B are an exemplary diagram of the event descriptor.

The event descriptor contains a “descriptor_tag” field and “descriptor_length” field representing the basic information of the descriptor, and a “number_sources” field and information having a loop structure for each source as information for correcting the time information of corresponding event of the EIT.

The event descriptor of FIG. 3A contains a “source_id” field and an “event_id” field.

The “source_id” field may contain source identifications (IDs) of all virtual channels belonging to a corresponding channel. For example, the “source_id” field has a source ID value identifying the virtual channel of an event broadcasted at the current time. The “event_id” field may contain event ID of all events in the virtual channels identified by the “source id” field. For example, the “event_id” field has an event ID value identifying an event broadcasted at the current time among all the events of the corresponding virtual channel.

The event descriptor of FIG. 3B contains a “source_id” field, an “event_id” field, and an “event_type” field. The “source_id” field and the “event_id” field was described in FIG. 3A and the aforementioned description will be cited.

The “event_type” field may represent the types of the corresponding event. That is, the “event_type” field represents the type of the current event defined by the “source_id” field and the “event_id” field. At this time, the type of the current event may be a generic broadcasting program when the value of the “event_type” field is ‘0x01’ and an advertisement when the value of the “event_type” field is ‘0x02’. The value of the “event_type” field is allocated with ‘0x03’ to ‘0xFF’ and may be used when the type of the current event is classified in more detail in the future.

Accordingly, the DTV receiver can more accurately recognize an event broadcasted at the current time among all the events of the virtual channels, and the type of the event through the STT received in a predetermined period. Accordingly, the DTV receiver may correct time information of corresponding event of the EIT. The efficiency of a system can be enhanced by changing the process of the event according to the type of the event, for example, in a case of an advertisement.

A transmitter transmits a STT section containing the event descriptor having the above-described configuration in a predetermined period, and a DTV receiver parses and uses the event descriptor contained in the STT section. Accordingly, it is possible to more accurately provide an event and enhance the convenience to a user. For example, when a reservation recording function or a recording function is used in the DTV receiver including a PVR function, only information desired by a user is accurately reservation-recorded or recorded and only information on the corresponding event is stored such that the efficiency of the system can be enhanced and a user can be satisfied.

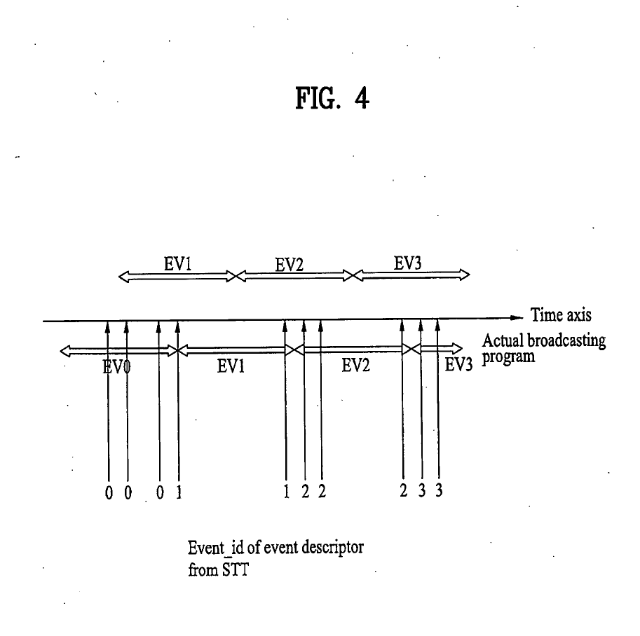

Hereinafter, an example of the use scenario of the event descriptor will be described. FIG. 4 is an exemplary process of searching for an accurate current event.

In the time axis of FIG. 4, it is assumed that a time passes from the left side to the right side. For example, events EV1 to EV3 according to the time information contained in the EIT are shown above the time axis. The actual broadcasting programs or events shown below the time axis, and the events EV1 to EV3 shown according to the time information contained in the EIT are different from each other in the time information. That is, the times of the actual broadcasting programs or events are more delayed than those of the time information contained in the EIT. At this time, the time information of the events contained in the EIT may vary by a variety of factors and the variation in time information can be solved by containing the event descriptor in the STT transmitted in the predetermined period.

Accordingly, a DTV receiver can obtain information on an event broadcasted at the current time using the event descriptor contained in the STT, instead of the time information (e.g. start_time field) of the EIT.

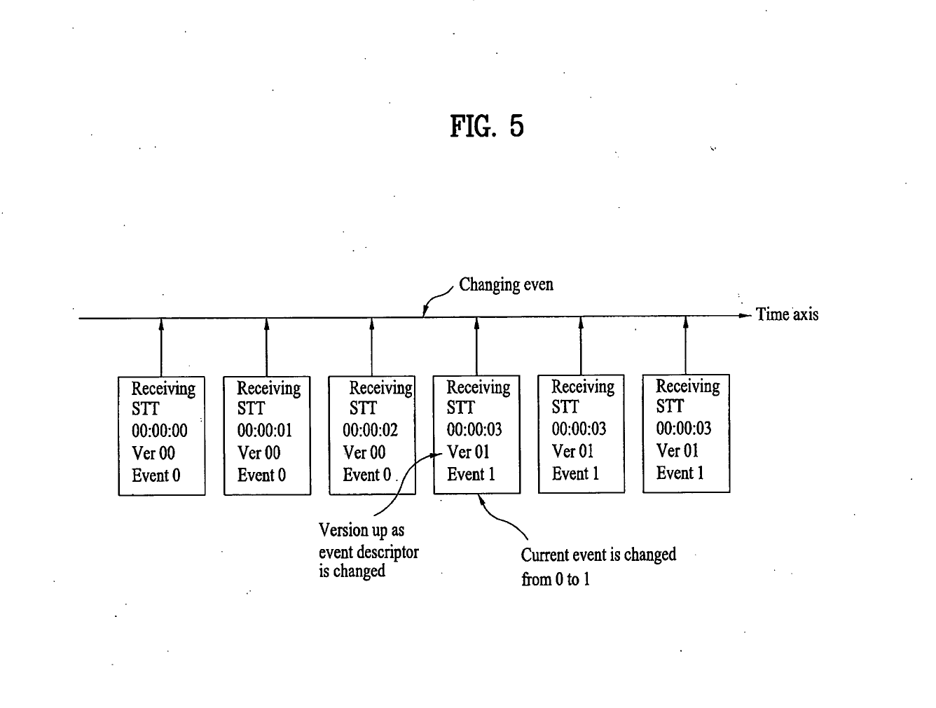

FIG. 5 is an exemplary case of using a version number when the event information in the event descriptor changes.

The event descriptor is defined in a form of descriptor of the STT section and value of each field in the event descriptor of the event broadcasted at the current time does not change whenever the STT section is received. Accordingly, when the value of the event descriptor changes using the version information (i.e. version_number field) of the STT section, the version information of the STT section is updated. When the STT section is received, the DTV receiver first checks the version information and parses the event descriptor only when the version information is updated. That is, as shown in FIG. 5, when the information on the event broadcasted at the current time, which is indicated by the event descriptor contained in the STT, changes (for example, from EV1 to EV2), the version number is updated. The DTV receiver parses the event descriptor only when the version number is updated. Accordingly, since the event descriptor is not parsed whenever the STT is received, it is possible to enhance the efficiency of the system without deteriorating performance. Alternatively, the version information may be contained in the event descriptor and used according to the above-described manner.

This is because the event information contained in the EIT is basically represented as information in three-hour units and the event information of the event descriptor does not change whenever the STT is received in a relatively short period. Accordingly, if a plurality of STT sections is carried, the information on the event broadcasted at the current time, indicated by the event descriptor of the received STT section, does not change and the same event is indicated until the event information changes at a specific time point.

Up to now, a case where the event descriptor according to the present implementation is contained in the STT section was described. Hereinafter, a case where the event descriptor is contained in a VCT section will be described.

The virtual channel table (VCT) contains a list of attributes for virtual channels carried in transport streams. The basic information contained in the VCT a message body includes transport stream (TS) ID, channel number (major and minor), short channel name, program number, access controlled flag, location field for extended text messages, and service type. Additional information may be carried by descriptors which may be placed in the descriptor loop after the basic information.

The VCT may be segmented into as many as 256 sections. One section may contain information for several virtual channels, but the information for one virtual channel shall not be segmented and put into two or more sections. Thus for each section, the first field after protocol_version shall be num_channels_in_section. Each virtual channel is associated with a program_number. Every program element associated with that program_number shall be considered to be a part of that virtual channel.

The VCT includes a terrestrial virtual channel table (TVCT) for terrestrial broadcasting and a cable virtual channel table (CVCT) for cable broadcasting. Hereinafter, the TVCT will be described as an example in the present implementation.

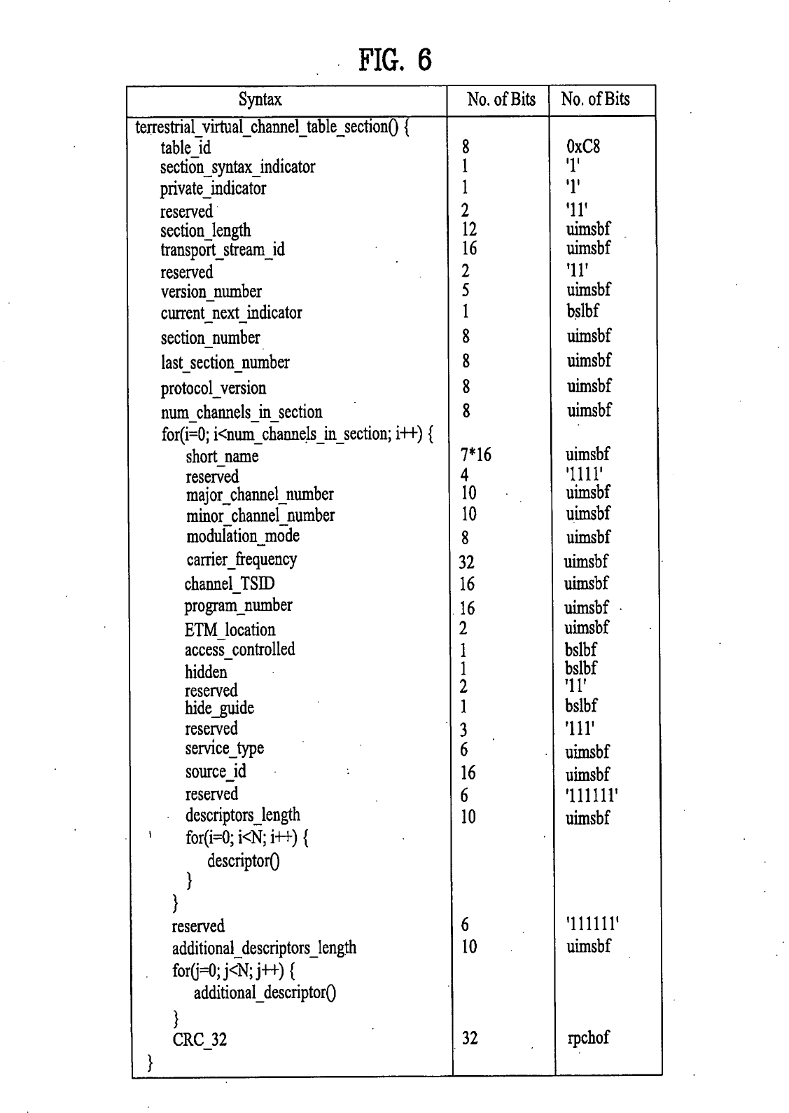

FIG. 6 is an exemplary diagram of a bit stream syntax terrestrial virtual channel table containing an event descriptor.

At this time, the header and the trailer of the TVCT section are substantially equal to those of the STT section shown in FIG. 2. Accordingly, the description of the header and trailer of the STT section shown in FIG. 2 will be cited and inferred and thus the detailed description thereof will be omitted. The header of the TVCT section contains a “transport_stream_id” field, which is the 16-bit MPEG-2 transport stream ID, as it appears in the program association table (PAT) identified by a packet identifier (PID) value of zero for this multiplex. The transport_stream_id distinguishes this TVCT from others that may be broadcasted in different PTCs.

Hereinafter, the message body of the TVCT section will be described.

A “num_channels_in_section” field is an 8-bit field, which specifies the number of virtual channels in this TVCT section. A “short_name” field is to represent the name of the virtual channel, represented as a sequence of one to seven 16-bit code values interpreted in accordance with the UTF-16 representation of Unicode character data.

A “major_channel_number” field is a 10-bit number that represents the “major” channel number associated with the virtual channel being defined in this iteration of the “for” loop. Each virtual channel shall be associated with a major and a minor channel number. The major channel number, along with the minor channel number, act as the user's reference number for the virtual channel. The major_channel_number shall be between 1 and 99. The value of major_channel_number shall be set such that in no case is a major_channel_number/minor_channel_number pair duplicated within the TVCT.

A “minor_channel_number” field is a 10-bit number in the range 0 to 999 that represents the “minor” or “sub”-channel number. This field, together with major_channel_number, performs as a two-part channel number, where minor_channel_number represents the second or right-hand part of the number. The value of minor_channel_number shall be set such that in no case is a major_channel_number/minor_channel_number pair duplicated within the TVCT. For other types of services, such as data broadcasting, valid minor virtual channel numbers are between 1 and 999.

A “modulation_mode” field is an 8-bit unsigned integer number that indicates the modulation mode for the transmitted carrier associated with this virtual channel. For digital signals, the standard values for modulation mode (values below ‘0x80’) indicate transport framing structure, channel coding, interleaving, channel modulation, forward error correction, symbol rate, and other transmission-related parameters, by means of a reference to an appropriate standard. The modulation_mode field shall be disregarded for inactive channels.

A “carrier_frequency” field has the recommended value for these 32 bits of zero. A “channel_TSID” is a 16-bit unsigned integer field in the range 0x0000 to 0xFFFF that represents the MPEG-2 transport stream ID associated with the transport stream carrying the MPEG-2 program referenced by this virtual channel. For inactive channels, channel_TSID shall represent the ID of the transport stream that will carry the service when it becomes active. The digital television receiver is expected to use the channel_TSID to verify that any received transport stream is actually the desired multiplex.

A “program_number” field is a 16-bit unsigned integer number that associates the virtual channel being defined here with the MPEG-2 program association and TS program map tables. An “ETM_location” is a 2-bit field that specifies the existence and the location of an extended text message (ETM). An “access_controlled” is a 1-bit Boolean flag that indicates, when set, that the events associated with this virtual channel may be access controlled. When the flag is set to ‘0’, event access is not restricted.

A “hidden” field is a 1-bit Boolean flag that indicates, when set, that the virtual channel is not accessed by the user by direct entry of the virtual channel number. Hidden virtual channels are skipped when the user is channel surfing, and appear as if undefined, if accessed by direct channel entry. Whether a hidden channel and its events may appear in EPG displays depends on the state of the hide_guide bit. A “hide_guide” field is a Boolean flag that indicates, when set to ‘0’ for a hidden channel, that the virtual channel and its events may appear in EPG displays. This bit shall be ignored for channels which do not have the hidden bit set, so that non-hidden channels and their events may always be included in EPG displays regardless of the state of the hide_guide bit. Typical applications for hidden channels with the hide_guide bit set to ‘1’ are test signals and services accessible through application-level pointers.

A “service_type” field is a 6-bit enumerated type field that shall identify the type of service carried in this virtual channel.

A “source_id” field is a 16-bit unsigned integer number that identifies the programming source associated with the virtual channel. In this context, a source is one specific source of video, text, data, or audio programming. Source ID value zero is reserved. Source ID values in the range ‘0x0001’ to ‘0x0FFF’ shall be unique within the transport stream that carries the VCT, while values ‘0x1000’ to ‘0xFFFF’ shall be unique at the regional level. Values for source_ids ‘0x0000’ and above shall be issued and administered by a Registration Authority designated by the ATSC.

A “descriptors_length” field indicates the total length (in bytes) of the descriptors for the virtual channel that follows. A “descriptor( )” field may include one or more descriptors, as appropriate. At this time, the descriptor includes, for example, the event descriptor. A detailed description of the event descriptor will be made later. An “additional_descriptors_length” field indicates the total length (in bytes) of the TVCT descriptor list that follows.

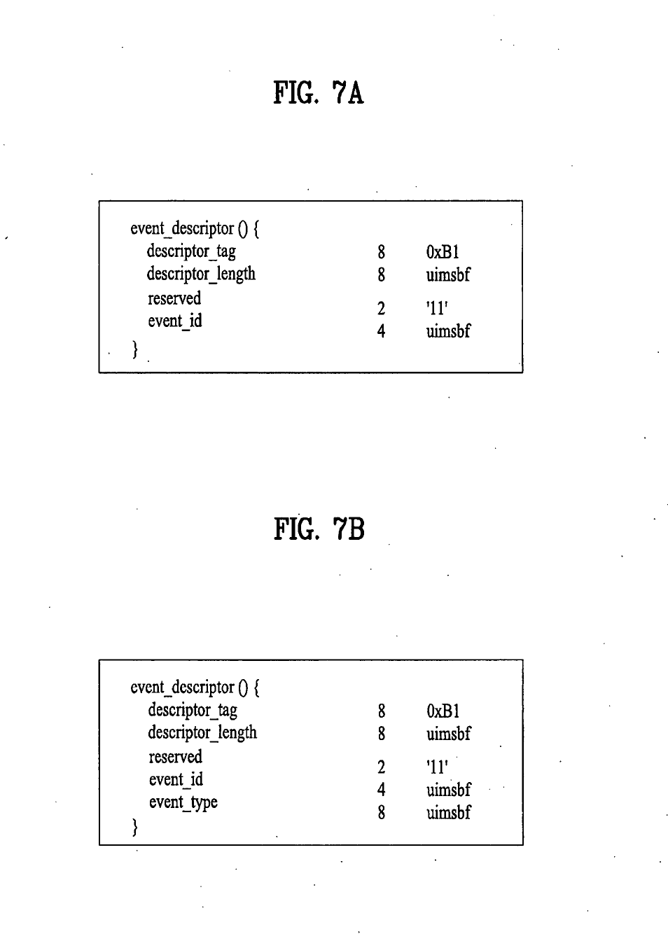

A case where the event descriptor is contained in the TVCT will be described. FIGS. 7A and 7B are an exemplary example of the event descriptor. With respect to the same portion of FIGS. 7A and 7B as FIGS. 3A and 3B, the description of FIGS. 3A and 3B will be cited.

Unlike FIGS. 3A and 3B, since the “source_id” field indicating all the virtual channels belonging to the corresponding channel is contained in the TVCT as shown in FIG. 6, the “source_id” field does not need to be contained in the event descriptor in FIGS. 7A and 7B.

Accordingly, the event descriptor shown in FIG. 7A contains only the “event_id” field about all the events corresponding to the virtual channels and the event descriptor shown in FIG. 7B contains information indicating the types of the events in addition to the field shown in the FIG. 7A.

As described above, when information (event descriptor) on an event broadcasted at the current time is contained in a specific table, such as a STT or VCT, in the PSIP, it is possible to more accurately supply the event by allowing a digital television receiver to use the event information although a difference between the time of the event and the time information contained in the EIT occurs due to a variety of factors.

When the specific table is contained, the event descriptor is not always parsed. That is, the event descriptor is parsed only when the version information of the table changes. Accordingly, it is possible to enhance the efficiency of the system.

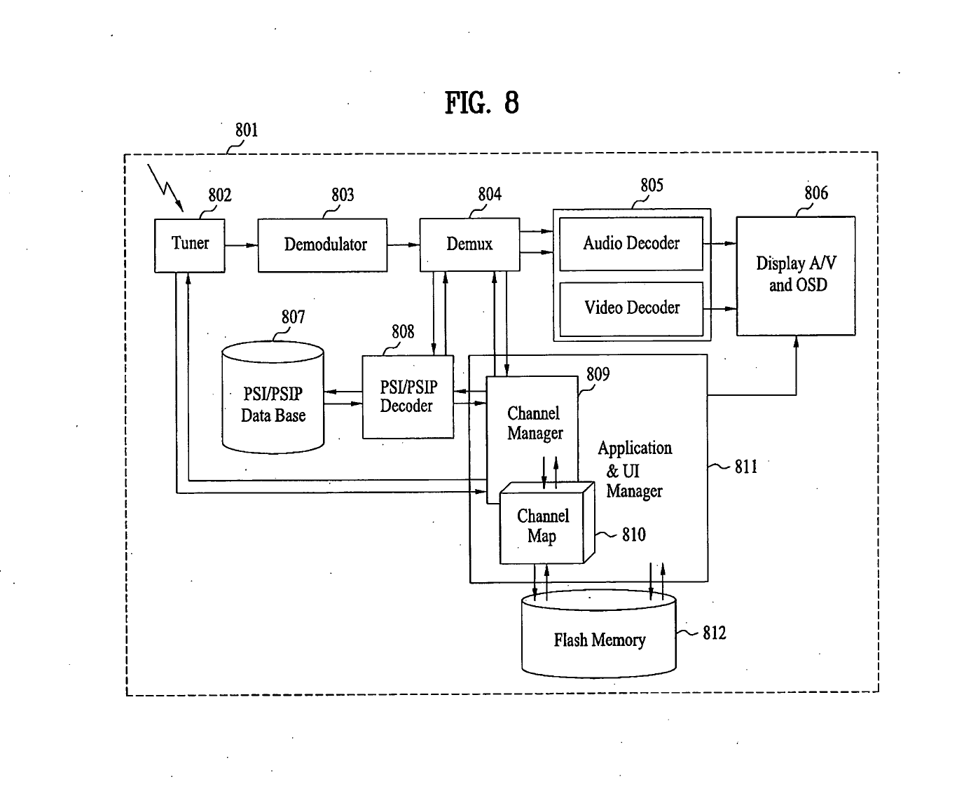

Hereinafter, a digital television (DTV) receiver for processing a digital television signal containing information on an event broadcasted at the current time will be described. FIG. 8 is an exemplary block diagram of a DTV receiver to process a DTV signal.

A DTV receiver 801 according to the present disclosure includes a tuner 802, a demodulator 803, a demultiplexer 804, an audio/video (A/V) decoder 805, a display A/V and on screen display (OSD) 806, a program specific information/program and system information protocol (PSI/PSIP) database 807 for storing parsed broadcasting program information of an EIT and an event descriptor included in a specific table, a PSI/PSIP decoder 808, a channel manager 809, a channel map 810, and an application and user interface (UI) manager 811.

The tuner 802 receives and tunes a DTV signal containing a PSI/PSIP table. A specific table of the PSI/PSIP table contained in the received DTV signal, for example, contains information on an event broadcasted at the current time. The tuner 802 is controlled by the channel manager 809 such that the control result is recorded in the channel manager 809.

The demodulator 803 demodulates the DTV signal tuned by the tuner 802 into a vestigal side band/enhanced vestigal side band (VSB/EVSB) signal.

The demultiplexer 804 demultiplexes an audio, video and PSI/PSIP table from transport packets demodulated by the demodulator 803. The demultiplexing of the PSI/PSIP table is controlled by the PSI/PSIP decoder 808 and the demultiplexing of the audio and video is controlled by the channel manager 809. And, the demultiplexer 804 filters the PSI/PSIP table sections demultiplexed. When the PSI/PSIP decoder 808 sets a packet identifier (PID) for a desired table as a condition, the demultiplexer 804 forms the sections of the PSI/PSIP table for satisfying the PID and transmits the sections to the PSI/PSIP decoder 808. When the channel manager 809 sets an A/V PID of a corresponding virtual channel as a condition, the demultiplexer 804 demultiplexes an A/V elementary stream (ES) and transmits the demultiplexed A/V ES to the A/V decoder 805.

The PSI/PSIP decoder 808 parses the PSI/PSIP table filtered by the demultiplexer 804 and records the parsed table information in the PSI/PSIP database 807. For example, the demultiplexer 804 filters the STT sections or TVCT sections containing the event descriptor controlled by the PSI/PSIP decoder 808. The PSI/PSIP decoder 808 parses the filtered STT or TVCT and records the parsed table information in the PSI/PSIP database 807. And, the PSI/PSIP decoder 808 updates the time information of the event according to the parsed current event information.

The channel manager 809 requests the reception of a channel-related information table by referring to the channel map 810 and receives the result. At this time, the PSI/PSIP decoder 808 controls the demultiplexer 804 to filter the channel-related information table and transmits a list of A/V PIDs contained in the channel-related information table received from the demultiplexer 804 to the channel manager 809. The channel manager 809 may directly control the demultiplexer 804 using the received A/V PID to control the A/V decoder 805.

The application and UI manager 811 controls a graphical user interface (GUI) for displaying the state of the receiver with an on-screen display (OSD).

For example, the channel manager 809 may request a current event to the PSI/PSIP database 807. The PSI/PSIP database 807 may search for the ID of the current event in the event descriptor contained in a specific table (e.g. STT or TVCT) according to the request. The PSI/PSIP database 807 searches for the event having the searched current event ID and returns the searched event to the channel manager 809.

As described above, the PSI/PSIP database 807 searches for the current event ID and the event having the ID and returns the result such that the channel manager 809 can recognize the event broadcasted at the current time. Accordingly, the channel manager 809 can manage a next operation using the returned value.

The demultiplexer 804 can check only the header of the table transmitted from the broadcasting station using the version_number. That is, the demultiplexer 804 can filter only the updated version_number field.

The display A/V and OSD 806 may display the event broadcasted at the current time using the event descriptor stored in the PSI/PSIP database 807 under the control of the application and UI manager 811.

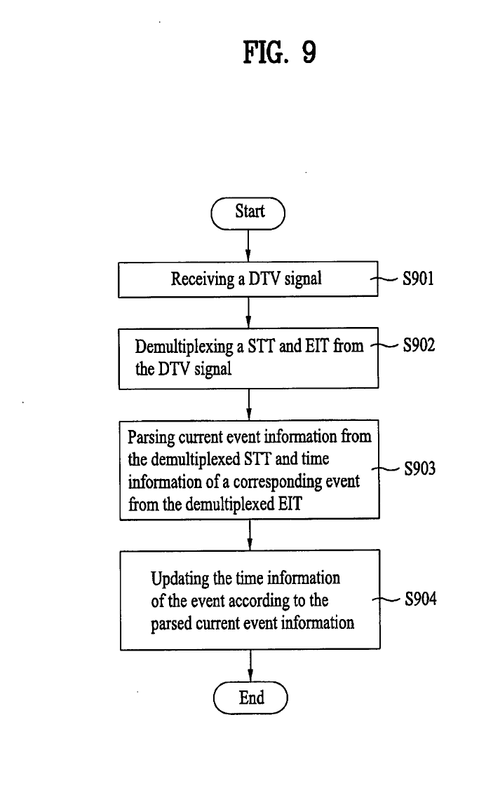

Next, a method for processing a digital television (DTV) signal in the above-described DTV receiver will be described with reference to the accompanying drawing. FIG. 9 is an exemplary flowchart of a method for processing a digital television signal.

First, the DTV receiver receives and demodulates a DTV signal (S901). At this time, the DTV signal, for example, contains a system time table providing a current date and time of day information and an event information table containing information for events on defined virtual channels.

The DTV receiver demultiplexes the STT and EIT from the demodulated DTV signal (S902).

And, the DTV receiver parses event descriptor from the demultiplexed STT. At this time, current event information in the event descriptor defines at least one of a source identification and event identification for a current event, and time information of a corresponding event from the demultiplexed event information table (S903).

Finally, the DTV receiver updates the time information of the event according to the parsed current event information (S904).

It may be determined whether the version number of the table containing the information indicating the event broadcasted at the current time changes. Accordingly, if it is determined that the version number changes, the information indicating the event broadcasted at the current time is parsed, a current event ID is extracted, and the information on the event having the same ID as the extracted event ID is outputted from the EIT. If it is determined that the version number does not change, the event information outputted previously may be outputted again or ignored.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of processing a digital television signal in a digital television receiver, the method comprising:
receiving a digital television signal including a system time table providing a current date and time of day information and an event information table containing information for events on defined virtual channels;
demultiplexing the system time table and the event information table from the digital television signal;
parsing current event information from the demultiplexed system time table, the current event information defining at least one of a source identification and event identification for a current event;
parsing time information of a corresponding event from the demultiplexed event information table; and
updating the time information of the event according to the parsed current event information.

2. The method of claim 1, wherein the current event information is parsed from the demutliplexed system time table only when a version number of the demultiplexed system time table is updated.

3. The method of claim 1, wherein the current event information comprises first information defining current event associated with virtual channel and second information defining identification number of current event described.

4. The method of claim 3, wherein the current event information further comprises third information defining type of current event.

5. The method of claim 4, wherein the type of current event is one of broadcast program and advertisement.

6. The method of claim 1, wherein time information comprises start time and length in seconds of corresponding event from the demultiplexed event information table.

7. A method of processing a digital television signal in a digital television receiver, the method comprising:
receiving a digital television signal including a virtual channel table containing a list of attributes for virtual channels carried in transport streams and an event information table containing information for events on defined virtual channels;
demultiplexing the virtual channel table and the event information table from the digital television signal;
parsing current event information from the demultiplexed virtual channel table, the current event information defining an event identification for a current event;
parsing time information of a corresponding event from the demultiplexed event information table; and
updating the time information of the event according to the parsed current event information.

8. The method of claim 7, wherein the current event information comprises first information defining identification number of current event described.

9. The method of claim 8, wherein the current event information further comprises second information defining type of current event.

10. The method of claim 9, wherein the type of current event is one of broadcast program and advertisement.

11. The method of claim 7, wherein time information comprises start time and length in seconds of corresponding event from the demultiplexed event information table.

12. A digital television receiver comprising:
a tuner tuning to a channel to receive a digital television signal;
a demodulator demodulating the digital television signal;
a demultiplexer demultiplexing a system time table and an event information table from the demodulated digital television signal;
a parser parsing current event information from the demultiplexed system time table and time information of a corresponding event from the demultiplexed event information table, the current event information defining at least one of a source identification and event identification for a current event; and a controller updating the time information of the event according to the parsed current event information.

13. The receiver of claim 12, wherein the current event information comprises first information defining current event associated with virtual channel and second information defining identification number of current event described.

14. The method of claim 13, wherein the current event information further comprises third information defining type of current event.

15. The method of claim 14, wherein the type of current event is one of broadcast program and advertisement.

16. The method of claim 12, wherein time information comprises start time and length in seconds of corresponding event from the demultiplexed event information table.

17. A digital television receiver comprising:
a tuner tuning to a channel to receive a digital television signal;
a demodulator demodulating the digital television signal;
a demultiplexer demultiplexing a virtual channel table and an event information table from the demodulated digital television signal;
a parser parsing current event information from the demultiplexed virtual channel table and time information of a corresponding event from the demultiplexed event information table, the current event information defining a event identification for a current event; and
a controller updating the time information of the event according to the parsed current event information.

18. The method of claim 17, wherein the current event information comprises first information defining identification number of current event described.

19. The method of claim 18, wherein the current event information further comprises second information defining type of current event.

20. The method of claim 19, wherein the type of current event is one of broadcast program and advertisement.

21. The method of claim 7, wherein time information comprises start time and length in seconds of corresponding event from the demultiplexed event information table.
